(19) United States
(12) Patent Application Publication
(10) Pub. No.: US 2005/0125423 A1
(43) Pub. Date: Jun. 9, 2005

(54) Method to provide a filter for the capture program of IBM/DB2 data replication

(76) Inventors: Hsien-Cheng Chou, Taipei (TW); Kan Wu, Hsinchu (TW); Franklin Wang, Kaohsiung City (TW); LetLong Chen, Tainan City (TW)

Correspondence Address: DUANE MORRIS, LLP;IP DEPARTMENT, ONE LIBERTY PLACE, PHILADELPHIA, PA, 19103-7396, US

(21) Appl. No.: 10/729,003

(22) Filed: Dec. 4, 2003

(51) Int. Cl. G06F 17/00

(52) U.S. Cl. 707/100

(57) ABSTRACT

In a data-replication system including a plurality of computers in communication with at least one network, each of said computers maintaining a substantially similar database thereon, a method and system applicable for filtering requests is disclosed. The method comprises the steps of capturing each of the requests, determining the consequences of the request, and precluding storing the consequences of the request when said request matches known criteria.

### FIELD OF THE INVENTION

This application is related to the field of electronic file management and more specifically to methods for improving efficiency in managing a plurality of databases which propagate data between databases with data replications.

### BACKGROUND OF THE INVENTION

IBM/Db2 data replication is a component of Db2 that performs data replication within or between databases. Data replication is useful to propagate manufacturing data, such as WIP (work in process), or to move data, such as equipment status, from a Computer Integrated Manufacturing (CIM) database to a legacy database for supply chain or data analysis, etc . . .

Rather than continuously transferring large data blocks to maintain the physically separated source and target tables between different databases, current data replication methods maintain a list or tables of changes made and provide the changes to the target tables. Hence, only the changes are provided to the target databases which maintain the changes and incorporate the necessary changes. This process is performed for each database as one database may be a source database that originates a change and may also be a target database for another database.

There are two major components in data replication—capture and apply; the apply process may filter changes by their values for specified columns but does not filter events. For example, the apply process may filter changes that meet the criteria for column, i.e., col_month, not equal to a current month. However, the apply process cannot set the filter criteria with regard to a “delete” event for when col_month does not equal the current month. The capture process, on the other hand, cannot filter changes either by values or by events.

For a heavy loading and mission critical system, such as a CIM system in an integrated circuit (IC) foundry fabrication process, the volume of transaction history data is huge and typically must be maintained for up to a year after the process is completed. Because data replication is enabled, all changes are captured and both normal transaction changes and data purging changes are replicated.

The behavior of data replication will triple the amount of transactions to propagate the changes. For example, to propagate an insert transaction, the capture process will do an insert, record the insert change for replication and prune the insert change record after replication. Similarly, a data purging transaction, which is larger than a normal transaction, will have a severe impact on processing. Accordingly, the data purging strategy is different between databases based on the different required period of history data in different databases. For example, a legacy database may require longer periods to maintain history data than on-line systems. In this case, it is better to purge data separately for different databases rather than through data replication.

Accordingly, there is a need for a method and a system for filtering potential large data purge operations when the source database information is determined to be “out-of-date” and must be replicated in associated databases.

### SUMMARY OF THE INVENTION

In a data-replication system including a plurality of computers in communication with at least one network, each of said computers maintaining a substantially similar data base thereon, a method and system applicable for filtering requests is disclosed. The method comprises the steps of capturing each of the requests, determining the consequences of the request, and precluding storing the consequences of the request when the request matches known criteria.

### BRIEF DESCRIPTION OF THE DRAWINGS

FIG. 1 illustrates graphically a conventional database replication system;

FIG. 2 illustrates graphically a process for data purge in a conventional data replication system;

FIG. 3 illustrates graphically a data purge operation in accordance with the principles of the invention in the replication system shown in FIG. 1;

FIG. 4 illustrates graphically a filtering process in accordance with the principles of the invention; and

FIG. 5 illustrates a flow chart of a filtering process for limiting data replication in accordance with the principles of the invention.

FIG. 6 illustrates a system for implementing the process illustrated in FIG. 5.

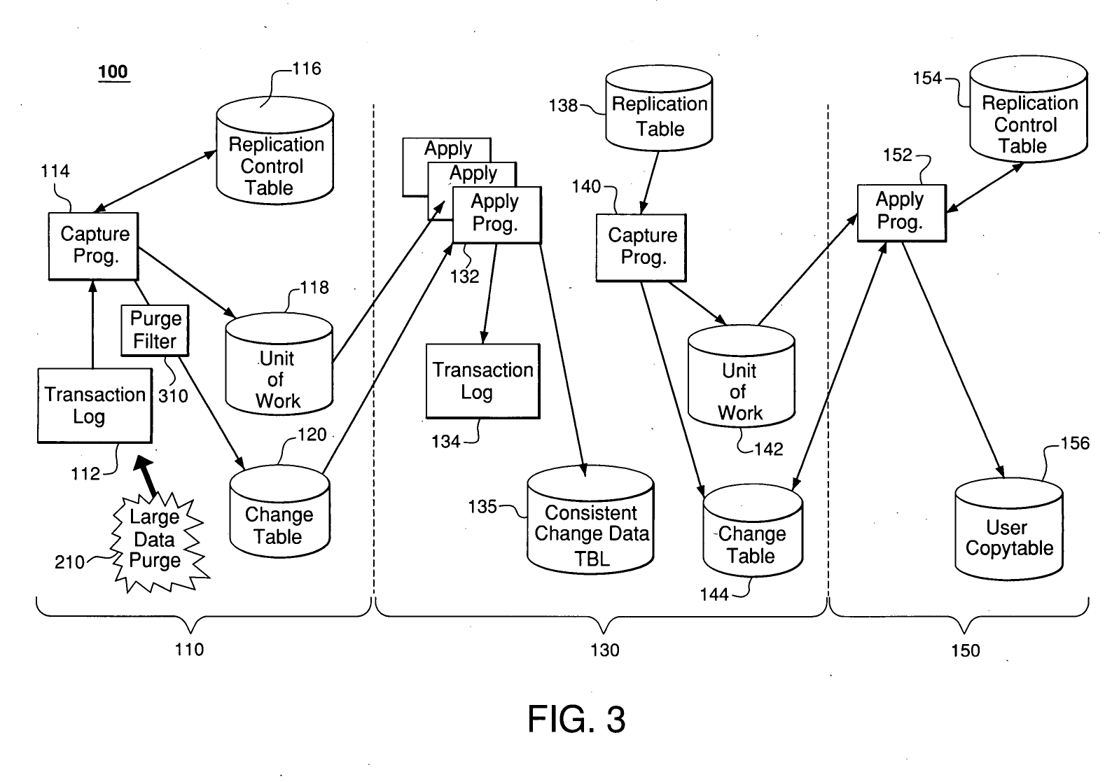

It is to be understood that these drawings are solely for purposes of illustrating the concepts of the invention and are not intended as a definition of the limits of the invention. The embodiments shown in FIGS. 3 through 6 and described in the accompanying detailed description are to be used as illustrative embodiments and should not be construed as the only manner of practicing the invention. Also, the same reference numerals, possibly supplemented with reference characters where appropriate, have been used to identify similar elements.

### DETAILED DESCRIPTION OF THE INVENTION

Definition of Terms
a. Source Table: registered as a replication source that will be recorded with all of the changes of a full database into a transaction log;
b. Transaction Log: includes the detail changes of the database since a last backup. This is used by replication software to record or log the record data changes. The transaction log is used to do a roll-forward in the case of a database disruption or “crash”. In this case, the database is recovered to the timestamp just before database crash by restoring it from previous backup. The gaps between the restored database and the detailed changes in the transaction log are used to recreate the database to at least near to the status before the system crash;
c. Control Tables: used to define the detail settings and synchronization of the data replication process;
d. Change Data (CD) Tables: record all changes, such as “committed,” “uncommitted” and “incomplete,” which are made to a replication source and inserted as rows into the CD table;
e. Unit-Of-Work (UOW) Tables: ensure data integrity by recording transactions that were committed at the source server;
f. Capture program: data replication program that performs the following functions:
   Scan Transaction Log to capture changes for each registered table and record changes to each corresponding Change-Data (CD) Table and Unit-of-Work (UOW) Table;
   Update the Control Tables to maintain synchronization of data replication; and
   Prune CD and UOW Tables;
g. Apply program: joins the CD and UOW Tables based on matched entries and copies the changes from the joined or combined CD and UOW to a target table.

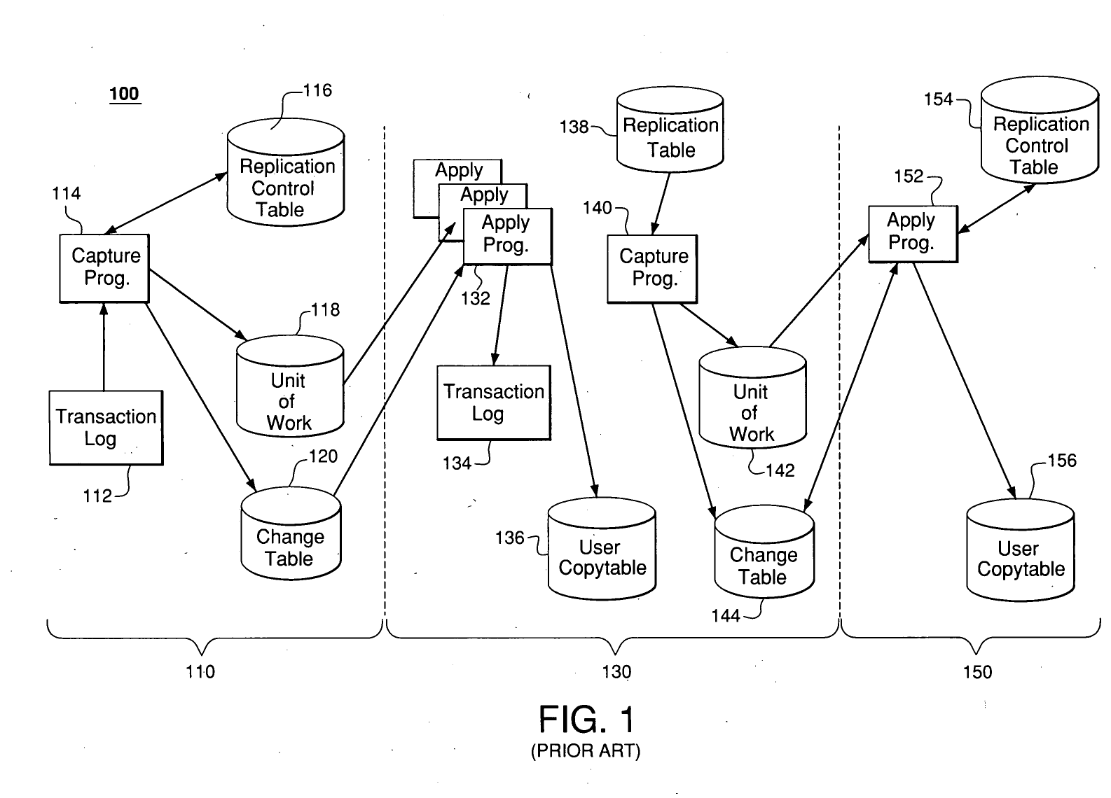

FIG. 1 illustrates, graphically, a conventional data replication system composed of a plurality of computer systems interconnected via one or more networks (not shown). In this graphic representation, three independent computer systems 110, 130 and 150, are functionally related to record changes that are introduced in any one of the systems. For example, a transaction applied to system 110 is entered on a Transaction Log 112 and provided to Capture program 114. Capture program 114 processes the entered transaction and provides the entered transactions to Replication Control Table 116, UOW Table 118 and Change Table 120. The entered transaction, denoted as changes to UOW Table 118 and Change Table 120, are then provided to system 130, via a network such as the Internet, to one or more Apply programs 132. Apply programs 132 merge the provided changes to create an entry that is applied to a similar transaction log 134 and a User Copy Table 136 at the corresponding computer system. The merge changes are further applied to Replication Control Table 138 which is then accessed by Capture program 140 to apply the changes to the UOW Table 142 and Change Table 144.

The changes applied to UOW Table 142 and Change Table 144 are then provided to one or more Apply programs 152 in system 150, where the changes are recorded in the Replication Control Table 154 and User Copy Table 156. Although system 150 is represented as a termination of the related systems, it should be recognized by those skilled in the art that the operations on system 150 may be similar in operation to system 130 in providing detected changes to additional systems.

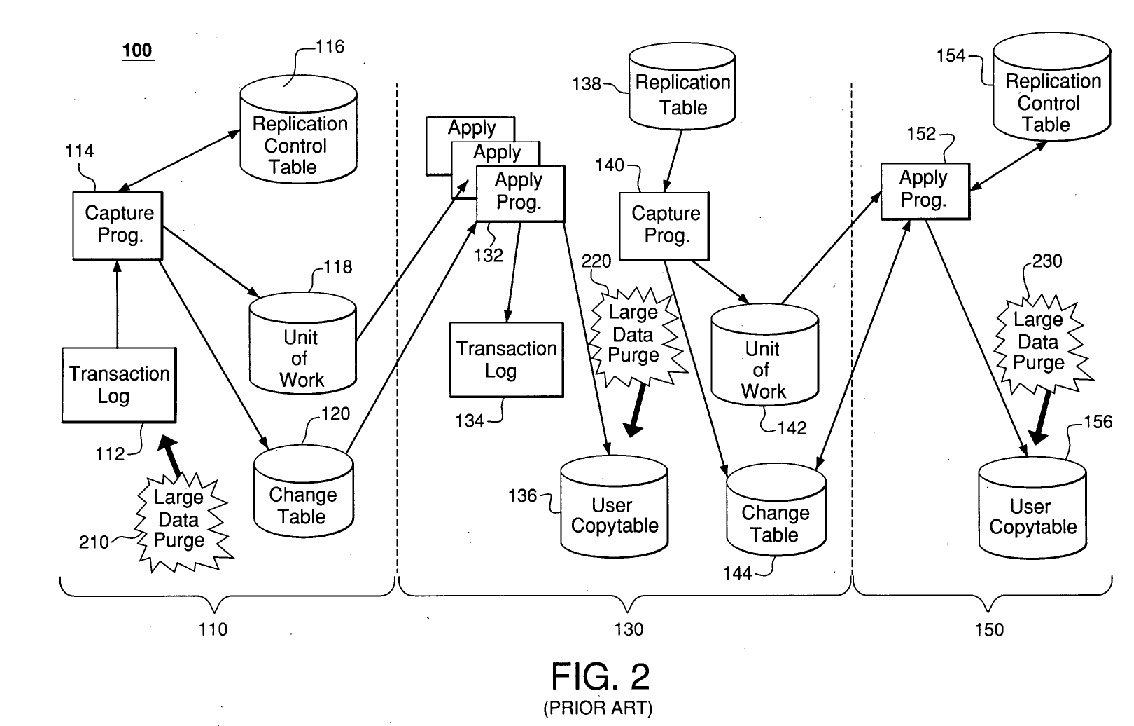

FIG. 2 illustrates, graphically, the processing associated with a purge of data in one of the files on system 110. In this case, a large data purge, presented as 210, is applied to transaction log 112, which applies the data purge to Capture Program 114. Capture Program 114 applies the changes associated with the data purge to Replication Control Table 116, UOW Table 118 and Change Table 120, as previously described. Hence, the changes for deleting or purging data are recorded and the data is then deleted. Furthermore, the recorded changes for deleting or purging data are then provided, in this case, to system 130 which similarly records the changes for deleting or purging data, as represented by block 220, and then proceeds to delete the data associated with the recorded changes. As previously described, the changes associated with the deleted data are then provided to system 150, which again records the associated changes and proceeds to delete the data from the files.

FIG. 3 illustrates, graphically, a process in accordance with the principles of the invention to limit the propagation of changes associated with data delete or purge requests. In this illustrated example, large data purge request 2 10 is applied to Transaction Log 112 and Capture program 114, as previously described. Capture program 114 includes a Purge filter which reviews the applied data request and determines whether a Purge request 210 has been made. If the Purge request 210 satisfies known criteria, then the data is removed, or marked as deleted and the Purge data request 210 is expunged from the request process. Accordingly, the purge data request 210 is prevented from being applied to the Change Data Table 120 and, consequently, from propagating further within the system of data replication systems, 130, 150.

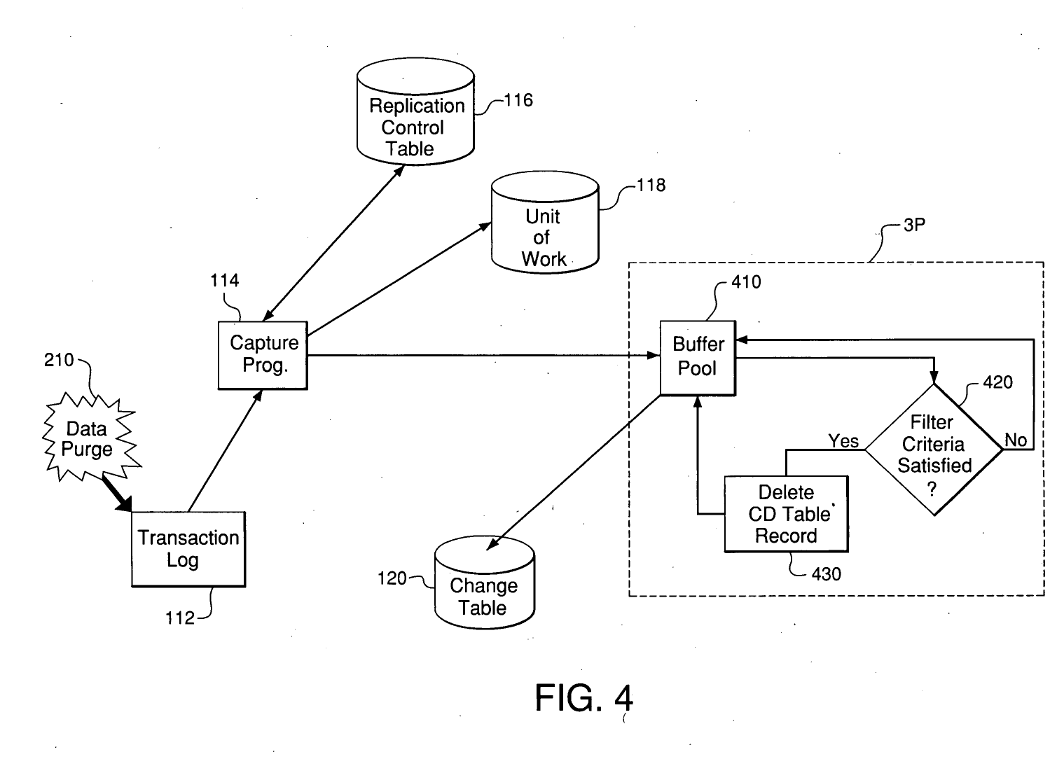

FIG. 4 illustrates an exemplary processing associated with the Purge filter 310 shown in FIG. 3. In this exemplary process, data purge 210 is received and all purging actions are recorded into Transaction Log 112. Capture Program 114 scans Transaction Log 112 and detects changes in tables registered in Replication Control Table 116. Capture program 114 may capture these changes and record them into Change Data Table 120 and UOW Table 118. Purge filter 310 associated with Capture program 114 reviews data in Change Data Table 120 and, as records are inserted into Change Data Table 120, filter 310 dynamically checks the incoming change data and causes the change data to be retained in memory, i.e., a buffer pool. The change data is thus not written to disk. The trigger or filter 310 may further check the event of changes in the Change Data Table as there is a column that records the event that occurred with the change, i.e., one of Insert/Update/Delete event. This is referred to as “IBMSNAP_OPERATION” wherein change tables to record changes of source tables are maintained by the system for each change table to record what kind of change happened with each record. And in one aspect a check for a “Delete” event is used as an indicator for filter 310.

A further check is made of the data values in the changed record if the data values meet specific criteria. For example, filter 310 may check a column entitled “claim_time” to determine whether the indicated event occurred at least six months ago. Further, if the event is marked as ‘D’, for delete, and the claim_time is at least six months ago, then filter 310 may determine the change is a “data purging” change. Filter 310 then causes the deletion of the record that happened at least six months ago. Filter 310 further submits a “delete request” with the change. However, the delete action will happen in memory and not from a disk. In this case, the change is not physically inserted into the change table and no actual delete action is recorded. However, if the data does not meet the specific filter criteria, the data is applied to Change Table 440.

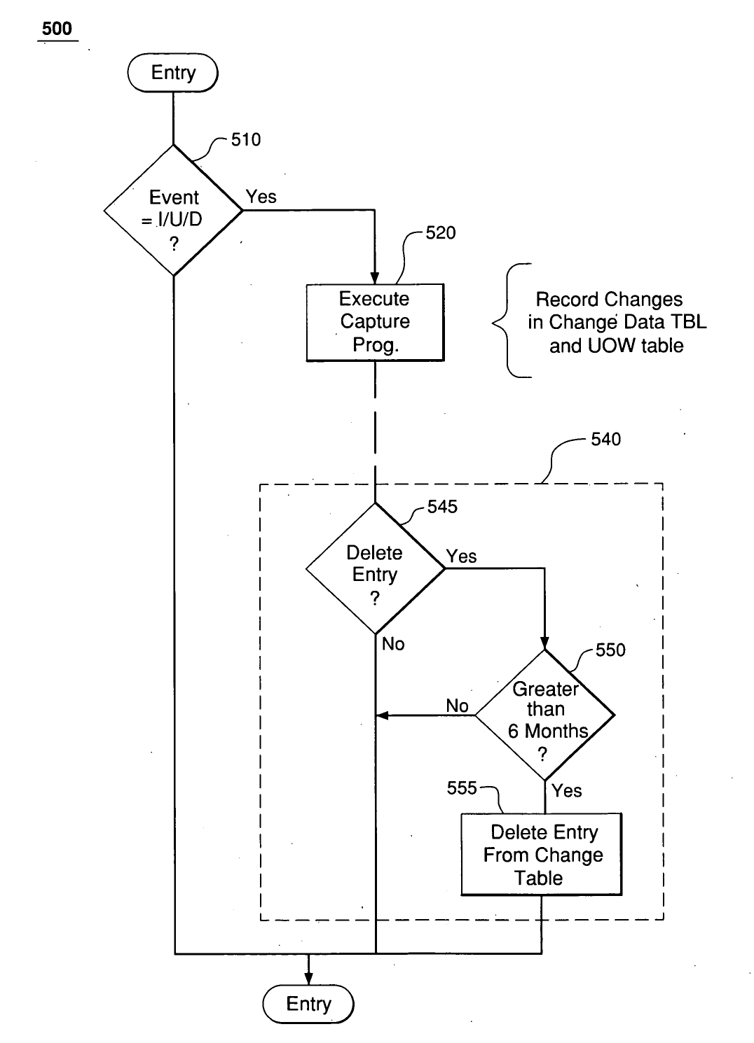

FIG. 5 illustrates an exemplary flow chart of the processing 500 in accordance with the principles of the invention. In this example, an event such as an Insert, Update or Delete entry is detected at block 510, a conventional capture program scans the changes into a transaction log and records the changes in a Change Data Table and a UOW Table at block 520. The entries into the Change Data Table are scanned or reviewed using a trigger program, which is shown in more detail in block 540. In this exemplary embodiment, trigger program 540 determines whether the data in the CD Table match, in this illustrative case, two specific filter criteria, i.e., the entry is marked as a “delete” entry, i.e., “D”, at block 545, and the last stored time is at least 6 months prior to the current time (or date) at block 550. If the entry matches the illustrated criteria, the record is deleted from the Change Data Table at block 555. Otherwise, the process exits and the entry in the Change Data Table is stored on disk. As previously discussed, the changes are further forwarded to other systems in the network.

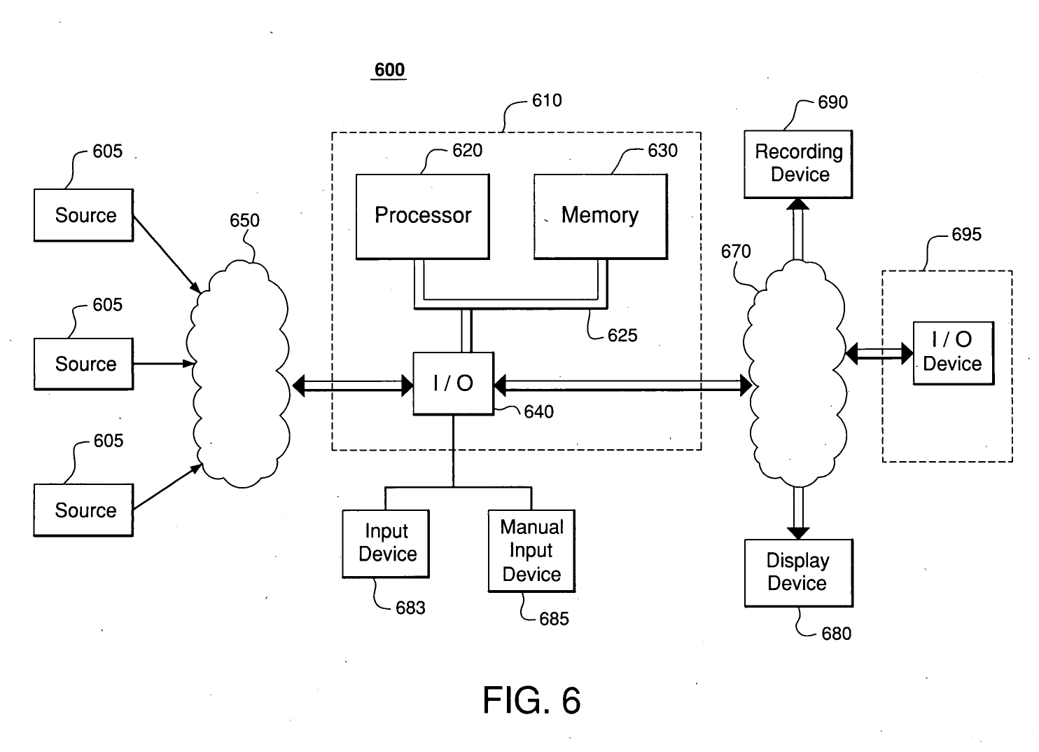

FIG. 6 illustrates a system 600 for implementing the principles of the invention as depicted in the exemplary processing shown in FIG. 5. In this exemplary system embodiment 600, input data is received from sources 605 over network 650 and is processed in accordance with one or more software programs executed by processing system 610. The results of processing system 610 may then be transmitted over network 670 for viewing on display 680, reporting device 690 and/or a second processing system 695.

More specifically, processing system 610 includes one or more input/output devices 640 that receive data from the illustrated source devices 605 over network 650. Processor system 610 may be representative of a handheld calculator, special purpose or general purpose processing system, desktop computer, laptop computer, palm computer, or personal digital assistant (PDA) device, etc., as well as portions or combinations of these and other devices that can perform the operations illustrated in FIG. 5. The received data is then applied to processor 620, which is in communication with input/output device 640 and memory 630. Input/output device 640, processor 620 and memory 630 may communicate over a communication medium 625. Communication medium 625 may represent a communication network, e.g., ISA, PCI, PCMCIA bus, one or more internal connections of a circuit, circuit card or other device, as well as portions and combinations of these and other communication media.

In one embodiment, processor 620 may include code which, when executed, performs the operations illustrated herein. The code may be contained in memory 630, read/downloaded from a memory medium such as a CD-ROM or floppy disk represented as 683, or provided by manual input device 685, such as a keyboard or a keypad entry, or may read data from a magnetic or optical medium (not shown) which is accessible by processor 620, when needed. Information items provided by input devices 683, 685 and/or a memory medium may be accessible to processor 620 through input/output device 640, as shown. Further, the data received by input/output device 640 may be immediately accessible by processor 620 or may be stored in memory 630. Processor 620 may further provide the results of the processing shown herein to display 680, recording device 690 or a second processing unit 695 through I/O device 640.

As one skilled in the art would recognize, the terms processor, processing system, computer or computer system may represent one or more processing units in communication with one or more memory units and other devices, e.g., peripherals, connected electronically to and communicating with the at least one processing unit. Furthermore, the devices may be electronically connected to the one or more processing units via internal busses, e.g., ISA bus, microchannel bus, PCI bus, PCMCIA bus, etc., or one or more internal connections of a circuit, circuit card or other device, as well as portions and combinations of these and other communication media, or an external network, e.g., the Internet and Intranet. In other embodiments, hardware circuitry may be used in place of or in combination with software instructions to implement the invention. For example, the elements illustrated herein may also be implemented as discrete hardware elements or may be integrated into a single unit.

As would be understood, the operation illustrated in FIG. 5 may be performed sequentially or in parallel using different processors to determine specific values. Processor system 610 may also be in two-way communication with each of the sources 605. Processor system 610 may further receive or transmit data over one or more network connections from a server or servers over, e.g., a global computer communications network such as the Internet, Intranet, a wide area network (WAN), a metropolitan area network (MAN), a local area network (LAN), a terrestrial broadcast system, a cable network, a satellite network, a wireless network, or a telephone network (POTS), as well as portions or combinations of these and other types of networks. As will be appreciated, networks 650 and 670 may also be internal networks, e.g., ISA bus, microchannel bus, PCI bus, PCMCIA bus, etc., or one or more internal connections of a circuit, circuit card or other device, as well as portions and combinations of these and other communication media or an external network, e.g., the Internet and Intranet.

While there have been shown, described, and pointed out fundamental novel features of the present invention as applied to preferred embodiments thereof, it will be understood that various omissions and substitutions and changes in the apparatus described, in the form and details of the devices disclosed, and in their operation, may be made by those skilled in the art without departing from the spirit of the present invention. It is expressly intended that all combinations of those elements that perform substantially the same function in substantially the same way to achieve the same results are within the scope of the invention. Substitutions of elements from one described embodiment to another are also fully intended and contemplated.

1. In a data-replication system including a plurality of computers on at least one network, each of said computers maintaining a substantially similar database thereon, a method applicable for execution on said computers for filtering requests over said at least one network comprising the steps of:
capturing each of said requests;
determining the consequences of said request; and
precluding storing said consequences of said request when said request matches known criteria.

2. The method as recited in claim 1, wherein said request is a delete request.

3. The method as recited in claim 1, wherein said criteria is associated with a known time period.

4. The method as recited in claim 3, wherein said time period is selected from the group consisting of: days, weeks, months, years.

5. The method as recited in claim 4, wherein said time period is six (6) months.

6. The method as recited in claim 1, wherein operation of said method is selected from the group consisting of: automatic, manual, fixed interval.

7. A system for filtering requests over at least one network comprising:
a processor in communication with a memory, said processor operable to execute code for the operations of:
capturing each of said requests;
determining the consequences of said request; and
precluding storing said consequences of said request when said request matches known criteria.

8. The system as recited in claim 7, wherein said request is a delete request.

9. The system as recited in claim 7, wherein said criteria is associated with a known time period.

10. The system as recited in claim 9, wherein said time period is selected from the group consisting of: days, weeks, months, years.

11. The system as recited in claim 10, wherein said time period is six (6) months.

12. The system as recited in claim 7, wherein said processor is further operable to execute code to perform said operations from the group consisting of: automatically, manually, fixed interval.

13. The system as recited in claim 7, further comprising:
an I/O device in communication with said processor and/or said memory.

14. The system as recited in claim 7, wherein said code is stored in said memory.
